(19) United States
(12) Patent Application Publication
(10) Pub. No.: US 2019/0342972 A1
(43) Pub. Date: Nov. 7, 2019

(54) LIGHT SOURCE POWER SUPPLY

(71) Applicant: EldoLAB Holding B.V., Son En Breugel (NL)

(72) Inventor: Xiaohong CHEN, Snellville, GA (US)

(21) Appl. No.: 16/473,843

(22) PCT Filed: Dec. 20, 2017
(86) PCT No.: PCT/NL2017/050858

§ 371 Date: Jun. 26, 2019

(30) Foreign Application Priority Data
Dec. 27, 2016 (NL) 2018081

(51) Int. Cl. H05B 33/08

(52) U.S. Cl. CPC H05B 33/0887; H02M 3/33523; H05B 33/0815

(57) ABSTRACT

A light source power supply circuit having multiple output channels is described, the light source comprising:
a front end circuit comprising a switched mode power converter configured to receive an input voltage and provide a regulated front end DC-voltage;
a plurality of power converter circuits, each of the power converter circuits of the plurality of power converter circuits being configured to receive the regulated front end DC voltage and provide a separate associated DC output for an associated one of the multiple output channels;
a fault detection circuit configured to detect the occurrence of a fault in one or more of the power converter circuits and output, in response, a fault signal;
wherein the front end circuit is provided with an input terminal for receiving the fault signal, and wherein the front end circuit is configured to adjust an output characteristic of the front end circuit based on the received fault signal.

### FIELD OF THE INVENTION

The invention relates to the field of light source power supplies, in particular to light source power supplies having multiple output channels, e.g. for powering multiple light sources or groups of light sources.

### BACKGROUND OF THE INVENTION

The invention relates to a light source power supply having multiple output channels for powering multiple light sources or groups of light sources. In particular, the present invention relates to meeting certain safety regulations for such power supplies in US. In US, certain power supplies are subject to safety regulations that are issued by the Underwriters Laboratory, e.g. the UL1310 Class 2 standard. This standard limits the voltage, current and power of each output channel of a power supply that is classified as a Class 2 supply. At present, the UL1310 Class 2 standard limits the power of a UL1310 Class 2 power supply to 100 W per output channel. Typically, power supplies that have multiple output channels have two power or voltage conversion stages, e.g. referred to as a front end stage and multiple back end stages. Such front end stage and/or back end stages may e.g. comprise switched mode power converter such as buck or boost converters or the like. In case the total nominal power of the back end stages would be larger than 100 W, it will be clear that the front end stage cannot be equipped, during normal operation, with a power limit of 100 W. Rather, the front end stage will be configured to be able to output the total nominal power to the back end stages. In such a situation, it may thus occur that, during a fault-condition or an unsafe operating condition in one of the back end stages, e.g. due to a shortage of an electronic switch such as a MOSFET of the back end stage, the front end supplies more than 100 W to the defective back end stage, thus breaching the UL1310 class 2 standard.

EP 2 073 605 A1 relates to lighting controller of a lighting device for a vehicle, wherein LED load fault condition can be detected. In case such a fault is detected, either all the LED's or the faulty LED can be switched off. However, this device does not provide for the detection of a fault in a power converter circuit. EP 2 533 608 A1 relates to a multiple channel light source power supply with output protection. When the current through a voltage converter circuit of a light source exceeds a predetermined value, a protection switch decouples either all light sources or said light source.

### SUMMARY OF THE INVENTION

It would be desirable to provide a light source power supply having multiple output channels which is adapted to comply with the UL1310 Class 2 standard when a fault condition occurs on one of the back end circuits of such a power supply.

To better address this concern, the present invention provides in a light source power supply having multiple output channels, comprising:
a front end circuit comprising a switched mode power converter configured to receive an input voltage and provide a regulated front end DC-voltage;
a plurality of power converter circuits, each of the power converter circuits of the plurality of power converter circuits being configured to receive the regulated front end DC voltage and provide a separate associated DC output for an associated one of the multiple output channels;
a fault detection circuit configured to detect the occurrence of a fault in one or more of the power converter circuits and output, in response, a fault signal;
wherein the front end circuit is provided with an input terminal for receiving the fault signal, and wherein the front end circuit is configured to adjust an output characteristic of the front end circuit based on the received fault signal.

The light source power supply according to the present invention comprises a front end circuit that is configure to receive, e.g. at an input terminal, an input voltage Vin. In an embodiment, the input voltage Vin may e.g. be a DC voltage, a rectified AC voltage or an AC voltage. In accordance with the present invention, the front end circuit is configured to convert the input voltage Vin to a regulated front end output voltage, in particular a regulated DC-voltage. In order to realize such a conversion, the front end circuit may e.g. comprise a switched mode power converter such as a Buck, Boost, fly-back, or hysteretic converter. In accordance with the present invention, the regulated DC-voltage as outputted by the front end circuit is provided to a plurality of power converter circuits, each of these circuits being configured to convert the regulated DC-voltage as received to a separate DC output supply, the plurality of separate DC output supplies forming a plurality of output channels to which a plurality of light sources or groups of light sources may be connected. In such an arrangement, the DC output supplies may be tailored to meet the requirements (e.g. with respect to voltage or current) of the light source connected to it.

In accordance with the present invention, the light source power supply further comprises a fault detection circuit that is configured to detect the occurrence of a fault in one or more of the power converter circuits and output, in response, a fault signal. Such a fault detection circuit may, in an embodiment, be arranged to sense an electrical characteristic of the power converter circuits, e.g. a voltage or current, and determine, based on the sensed characteristic, a fault signal. In an embodiment, the occurrence of a fault condition in one of the power converter circuits may also be determined based on a measured characteristic of the front end circuit, e.g. an output voltage or output current of the front end circuit.

In case a fault is detected, the fault detection circuit provides, in accordance with the present invention, a fault signal to the front end circuit, e.g, to an input terminal of the front end circuit, whereupon, the front end circuit adjusts an output characteristic of the front end circuit based on the received fault signal. Examples of such adjustments may e.g. include adjusting an output power limit of the front end circuit or an output current limit of the front end circuit or even reducing a maximum switching frequency of a switch of the front end circuit. As a result of such adjustment, an effective limitation of the power consumed by the front end circuit can be realized, enabling the light source to meet with safety regulations such as the UL1310 Class 2 standard. Advantageously, the invention does not require to decouple one or more of the light sources. Instead, the total power consumed by the light sources combined in limited, by limiting the power which the front end circuit can consume. By limiting the total power consumed, the light sources can still be supplied with power after the adjustment, but do not violate safety regulations such as the UL1310 Class 2 standard.

Thus, in an embodiment, the plurality of power converter circuits are configured to still provide the separate associated DC output for the associated one of the multiple output channels after the adjustment of the output characteristic of the front end circuit.

These and other aspects of the invention will be more readily appreciated as the same becomes better understood by reference to the following detailed description and considered in connection with the accompanying drawings in which like reference symbols designate like parts.

### BRIEF DESCRIPTION OF THE DRAWINGS

FIG. 1a depicts a first embodiment of a light source power supply according to the present invention.

FIG. 1b depicts a front end circuit and an overload protection circuit as can be applied in the light source power supply according to the present invention.

FIG. 2 depicts a fly-back converter as can be applied in a power supply according to the present invention.

FIG. 3 depicts a voltage conversion circuit as can be applied in a power supply according to the present invention.

### DETAILED DESCRIPTION OF EMBODIMENTS

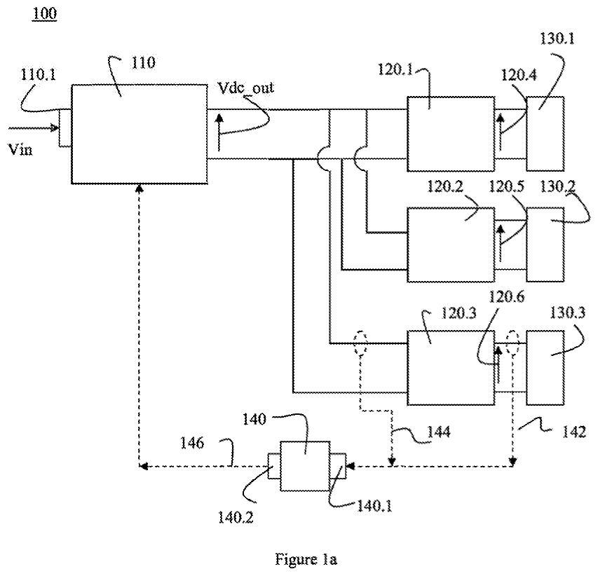

FIG. 1a schematically depicts a light source power supply 100 according to an embodiment of the present invention. The light source power supply 100 comprises a front end circuit 110 configure to receive, e.g. at an input terminal 110.1, an input voltage Vin. In an embodiment, the input voltage Vin may e.g. be a DC voltage, a rectified AC voltage or an AC voltage. In accordance with the present invention, the front end circuit 110 is configured to convert the input voltage Vin to a regulated front end output voltage, in particular a regulated DC-voltage Vdc_out. in order to realize such a conversion, the front end circuit may e.g. comprise a switched mode power converter such as a Buck, Boost, fly-back, or hysteretic converter. In accordance with the present invention, the regulated DC-voltage as outputted by the front end circuit is provided to a plurality of power converter circuits 120.1, 120.2, 120.3, each of the power converter circuits being configured to convert the regulated DC-voltage as received to a separate DC output supply, the plurality of separate DC output supplies 120.4, 120.5, 120.6 forming a plurality of output channels to which a plurality of light sources or groups of light sources 130.1. 130.2, 130.3 may be connected. In such an arrangement, the power converter circuits, which may also be referred to as back end circuits, may be individually controlled so as to provide the best suited output for powering the light sources connected to the output channels. In accordance with the present invention, the light source power supply further comprises a fault detection circuit 140 that is configured to detect the occurrence of a fault in one or more of the power converter circuits and output, in response, a fault signal. In an embodiment, the fault detection circuit is configured to sense an output characteristic of one or more of the plurality of power converter circuits 120.1, 120.2, 120.3, e,g. one or more of the DC output supplies 120.4, 120.5, 120.6, such sensing being indicated by the dotted line 142. In such embodiment, the fault detection circuit may e.g. comprise a voltage sensing circuit or current sensing circuit configured to provide, e.g. at an input terminal 140.1 of the fault detection circuit 140, a voltage resp. current signal.
Alternatively, or in addition, the fault detection circuit may be configured to sense an output characteristic of the front end circuit, e.g. by means of a voltage or current sensing circuit that is configured to provide, e.g. at the input terminal 140.1 of the fault detection circuit 140, a voltage resp. current signal representative of the output voltage or output current as provided by the front end circuit 110 (indicated by the dotted line 144).

In accordance with the present invention, the fault detection circuit 140 as applied in the light source power supply 100 is configured to detect the occurrence of a fault in one or more of the power converter circuits and output, in response, a fault signal 146, e.g. via, an output terminal 140.2 of the fault detection circuit. As such, the fault detection circuit is configured to assess, e.g. based on one or more signals received at the input terminal 140.1 of the fault detection circuit, whether or not a fault has occurred in one or more of the power converter circuits and output a fault signal 144. As an example of such a fault, a short-circuiting of a switch applied in the power converter circuits may e.g. be mentioned. As an example, the power converter circuits as applied in the light source power supply according to the present invention may e.g. be equipped with switched mode power converters such as Buck or Boost or Buck-Boost converters. By means of such converters, the voltage Vdc_out as received from the front end circuit 110 may be converted to a required output voltage for powering a particular light source. In case of a malfunctioning of the switched mode power converter, e.g. due to a short-circuiting of a power-electronic switch of the converter, an output characteristic of the power converter circuit, e.g. one of the circuits 120.1 120.2 or 120.3 may change and this change may be detected. In addition, the occurrence of a fault condition in one or more of the power converter circuits 120.1, 120.2 or 120.3 may also change the output characteristic of the front end circuit. Such changes may be detected and processed by the fault detection circuit 140. In case a fault is detected, the fault detection circuit provides a fault signal to the front end circuit, e.g. to an input terminal of the front end circuit and the front end circuit adjusts an output characteristic of the front end circuit based on the received fault signal 144. Examples of such adjustments may e.g. include adjusting an output power limit of the front end circuit or an output current limit of the front end circuit or even reducing a maximum switching frequency of a switch of the front end circuit. As a result of such adjustment, an effective limitation of the power consumed by the front end circuit can be realized, enabling the light source to meet with safety regulations such as the UL1310 Class 2 standard.

Various embodiments of the invention will now be discussed in more detail. The present invention provides in various manners to derive the occurrence of a fault condition in one or more of the power converter circuits. More details on how the occurrence of a fault may be determined are provided below.

Once the fault has been determined and a fault signal indicative of the occurrence of a fault has been fed back to the front end circuit, the operation of the front end circuit is adjusted. In particular, the adjustment of the behavior of the front end circuit of the light source according to the present invention may be such that the requirements for the UL1310 Class 2 standard are met. In accordance with the present invention, this can be realized in different manners. As a first example, a setting of an overload protection (OLP) circuit of the light source power supply may be adjusted in case of the occurrence of a fault. More specifically, the protection limit of the overload protection circuit may be lowered when a fault occurs. In order to comply with the UL1310 Class 2 standard, the power supply per output channel of a light source power supply having multiple output channels is limited to 100 W per output channel. In case the total nominal power of as outputted by the plurality of power converter circuits would be larger than 100 W, it will be clear that the front end circuit cannot be equipped, during normal operation, with a power limit of 100 W. Rather, the front end circuit should be equipped to be able to output the total nominal power to the power converter circuits or back end circuits. As such, when a light source having multiple output channels is equipped with an overload protection circuit, the threshold for triggering the overload condition will usually be set to a value higher than 100 W. In an embodiment of the present invention, the light source power supply is configured to reduce this threshold for triggering the overload condition, when a fault condition is detected.

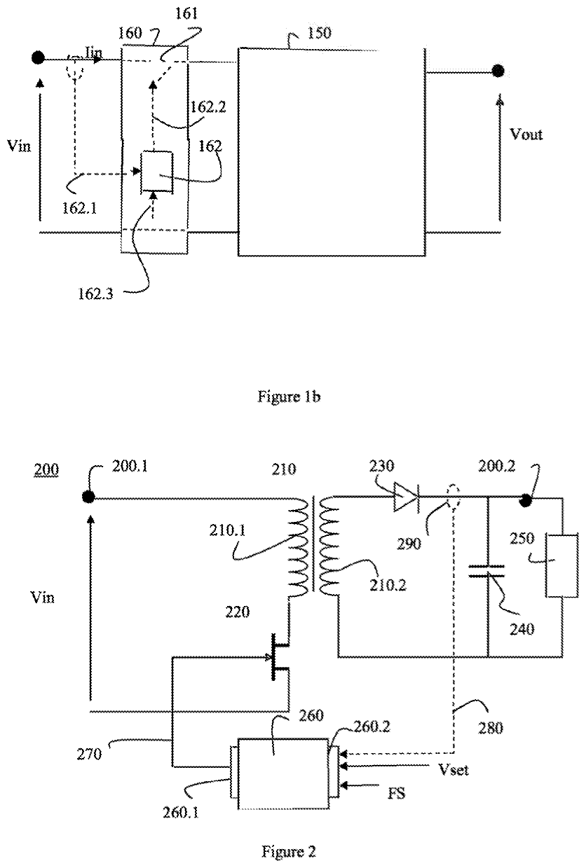

FIG. 1b schematically shows such an arrangement. FIG. 1b schematically shows part of an embodiment of a light source power supply according to the present invention, including a front end circuit 150, the front end circuit configured to receive an input voltage Vin and provide a regulated front end DC-voltage Vout. In the embodiment as shown, the input voltage Vin is provided to the front end circuit via an overload protection circuit 160, the overload protection circuit 160 comprising a switch 161 and a control unit 162 for controlling the switch 161. In the embodiment as shown, the control unit 162 is configured to receive an input signal 162.1 representative of the power consumed by the front end circuit. In an embodiment, the input signal 162.1 may comprise a first signal representing the voltage Vin and a second signal representing the current Iin, i.e. the current provided to the front end circuit. During normal operation, the control unit 160 controls the switch 161 to a closed position, indicated by the control signal 162.2, provided the power consumed is smaller than a predetermined, e.g. pre-set value. Such value may e.g, be stored in a memory unit of the control unit 162. As an example, in case the front end circuit is configured to supply power to 4 power converter circuits, each configured to power a 50 W load, the control unit 162 may be configured to keep the switch closed as long as the input signal 162.1 indicates that the power as consumed by the front end. circuit is below 200 W. In such embodiment, the control unit 162 may e.g. comprises a comparator for comparing the 200 W limit, e.g. stored in a memory unit of the control unit, to the actual consumed power, derived from the input signal 162.1. In the embodiment as shown, the control unit 162 is further configured to receive a fault signal 162.2 indicating that that a fault has occurred in one of the power conversion circuits that are powered by the front end circuit. Upon receipt of such a signal, the control unit 162 may be configured to adjust the stored power limit to a value matching the UL1310 Class 2 standard, in particular, the control unit 162 may be configured to set the power limit to 100 W. As a result, in case the power as consumed by the front end circuit would reach 100 W or more, the control unit 162 would control the switch 161 to open.
As a second example, the occurrence of a fault condition in one of the power converter circuits may be used to modify a current limit as set in an overcurrent protection circuit of the power source. In an embodiment, the power source according to the present invention may be provided with an overcurrent protection circuit that ensures that the current as drawn by the front end circuit does not go beyond a predetermined limit. In order to assess this, the overcurrent protection circuit may be provided with a sensing resistor arranged to generate a signal proportional to the current drawn by the front end circuit. Such current signal may e.g. be provided to a control unit of the front end circuit, in order to monitor the current as drawn. Upon the occurrence of a fault condition in one of the power conversion circuits, the current signal as provided to the control unit may e.g. be elevated to a level indicative of a current that is above the overcurrent protection limit of the overcurrent protection circuit. By doing so, the control unit of the front end circuit will control the front end circuit to operate in an overload mode or latch mode, thereby limiting the power drawn by the power source to a value lower than the power limit as set by the UL1310 Class 2 standard.
In a similar manner, the output voltage of the front end circuit, i.e. the regulated DC output voltage, could be reduced upon the occurrence of a fault condition. By doing so, one can also realize that the output power as delivered by the front end (FE) is limited, e.g. to meet the UL1310 Class 2 standard requirements. In order to lower the output voltage of the front end circuit the switching frequency of the front end circuit, in particular of the switched mode power supply of the front end circuit, may be adjusted, thereby lowering the output voltage Vdc_out. In an embodiment, the front end circuit may comprise a fly-back converter for generating the regulated front end DC voltage. Such an arrangement is schematically shown in FIG. 2. FIG. 2 schematically shows a fly-back converter 200 configured to receive an input voltage Vin, e.g. a DC voltage or rectified AC voltage, at an input terminal 200.1, the fly-back converter comprises a primary circuit connected to the input voltage, the primary circuit comprising a primary winding 210.1 of a transformer 210 and a switch 220. The fly-back converter further comprises a secondary circuit comprising a secondary winding 210.2 of the transformer, a diode 230 and a capacitance 240, also referred to as the output capacitance of the fly-back converter.

By appropriate switching of the switch 220 of the primary circuit, the capacitance 240 is charged and the voltage over the capacitance is made available at an output terminal 200.2 of the fly-back converter, e.g. for powering a load 250. By controlling the switching frequency of the switch 220, one can control the amplitude of the voltage available at the output terminal 200.2, i.e. the regulated output voltage Vdc_out of the fly-back converter. In the embodiment as shown, the fly-back converter further comprises a control unit 260 that is configured to control the switch 220 by means of a control signal 270, outputted via the output terminal 260.1 of the control unit. In the embodiment as shown, the control unit is configured to receive, at an input terminal 260.2 of the control unit 260, a set point Vset representing a desired value of the output voltage Vdc_out and a signal 280 representing a measured value of the output voltage Vdc_out, the latter e.g. being obtained from a voltage sensing circuit 280.

When applied as a front end circuit in a light source power supply according to the present invention, the output voltage Vdc_out of the flyback converter 200 may be connected to a plurality of power conversion circuits, as e.g. shown in FIG. 1a.
In such an arrangement, the control unit 270 may further be configured to receive, e.g. at the input terminal 260.2 a fault signal FS, representing that a fault has occurred in one of the power conversion circuit connected to the output terminal 200.2 of the fly-back converter. In an embodiment, the fault signal FS may e.g. be provided to the input terminal 260.2 via an opto-coupler. In accordance with the embodiment of the present invention, the control unit 260 of the fly-back converter 200 may then be configured to control the switch 220 based on the fault signal FS, in particular, the control unit 260 may be configured to control the fly-back converter 200 to a reduced output voltage Vdc_out such that the maximum power that can be delivered to the plurality of power converter circuits remains below the limit as dictated by the UL1310 Class 2 standard, e.g. by controlling the switching frequency of the switch 220 to a low or lower value. In an embodiment of the present invention, a control unit of the front end circuit that controls a switch of the front end circuit may be configured to limit the switching frequency of the switch to a predetermined value. Typically, this value may be set comparatively high to ensure that sufficiently high voltage may generated during normal operating conditions. However, during the occurrence of a fault condition, the control unit may be configured to adjust the upper limit of the switching frequency, e.g. reducing the applied upper limit of the switching frequency, thereby limiting the output voltage of the front end. As a result, the power as drawn by the front end circuit can be limited as well.

In a embodiment of the present invention, the functionality of the fault detection circuit 140 as schematically shown in FIG. 1a may be incorporated in the control unit 260 of the front end circuit, e.g. the fly-back converter 200. In such an arrangement, the control unit 260 may e.g. be configured to determine, based on a voltage or current signal received, whether or not a fault condition has occurred in one or more of the power conversion circuits of the light source power supply. In such an arrangement, the control unit 260 may e.g. be configured to determine whether or not a fault condition has occurred, based on the signal 280 representing a measured value of the output voltage Vdc_out. In particular, the evaluation of whether or not a fault condition has occurred may be made based on a processing of the signal 280 as received. As an example, the occurrence of a fault condition may e.g. be detected based on a ripple voltage occurring on the output capacitance 240 of the fly-back converter 200. In particular, in case the voltage ripple on the output voltage Vdc_out is above a predetermined threshold, this may be an indication of the occurrence of a fault downstream, i.e. a fault in one of the power converter circuit of the power supply. In case such a fault condition is met, the control unit 260 of the fly-back converter may reduce, by means of an appropriate control signal 270, the switching frequency of the fly-back converter 200, in order to reduce the power supplied to the load, i.e. the plurality of voltage conversion circuits.

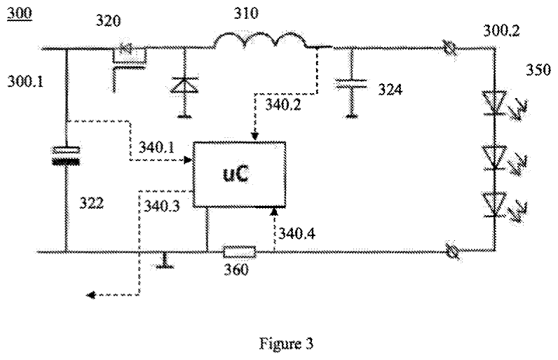

As a first example of how a fault condition may be detected in a voltage conversion circuit a voltage measurement over a switch of the conversion circuit can be mentioned. This is schematically illustrated in FIG. 3.
FIG. 3 schematically shows an example of a power conversion circuit as may be applied in an embodiment of the present invention. The power conversion circuit 300 comprises an input terminal 300.1 and an output terminal 300.2 to which a load 350 is connected, e.g. three LEDs connected in series. The voltage conversion circuit 300 as shown is a switched mode power converter comprising a switch 320, e.g. a MOSFET, an inductance 310, a freewheeling diode, an input capacitance 322 and an output capacitance 324. The voltage conversion circuit 300 further comprises a controller or control unit 340 that is configured to control a switching operation of the switch 320. In the embodiment as shown, the control unit 340 is further configured to receive, e.g. at an input terminal, a first input signal 340.1 representing the input voltage Vin as provided at the input terminal 300.1 and a second input signal 340.2 representing the output voltage Vout as provided at the output terminal 300.2. The difference between both signals may be used to assess the proper operation of the switch 320. In case the voltage difference between Vin and Vout is smaller than a predetermined value, the control unit 340 may consider the switch 320 to be defective, i.e. short-circuited, and output a fault signal 340.3, indicative that the switch 320 is defective. It is noted that when the switch 320 is a MOSFET, the first input signal 340.1 can represent the voltage at the drain side of the MOSFET and the second input signal 340.2 can represent the voltage at the source side of the MOSFET. The first and second input signal 340.1, 340.2 thus enable to detect when the MOSFET is short-circuited.
As an example, the predetermined value of the voltage difference that triggers the occurrence of a fault condition may e.g. be 2 V. In case the switch 320 would be defective, i.e. permanently shorted, the voltage drop across the inductance 310 would rapidly decrease to zero. Typically, the voltage difference between the supply voltage Vin at the input terminal 300.1 (i.e. the voltage across the input capacitor 322) and the required voltage Vout for powering the LEDs 350 (i.e. the voltage at the output terminal 300.2) is selected substantially larger than 2 V, e.g. 10 V or more. Therefore, during normal operation, the voltage difference between Vin and Vout should not go below 2V. It can however be pointed out that the input voltage Vin has a ripple; every 10 ms (in case of a 50 Hz mains supply), the momentary voltage at the input terminal has a lowest value that may be close to the required voltage Vout. However, a fault detection circuit does not need to respond, in the present application, within 10 ms. As such, the fault detection circuit may be configured to apply as a second condition that the voltage difference Vin−Vout should remain below the predetermined value (e.g. 2V) during at least a predetermined period, e.g. >100 ms or more. The predetermined period may e.g. depend on the criteria as required by the UL1310 Standard; in case of a not-inherently limited device, the UL1310 Standard criteria stipulate that the fault condition should take less than 2 minutes. As such, the predetermined period during which the voltage difference should remain below the predetermined value may e.g. 1 sec. In case the fault conditions are met, a fault signal 340.3 can be generated. Such a fault signal may e.g. be provided to a fault detection circuit 140 as e.g. shown in FIG. 1a. Alternatively, the first and second input signals 340.1 and 340.2 may also be directly provided to a fault detection circuit, e.g. a separate fault detection circuit such as circuit 140 of FIG. 1a or a fault detection circuit integrated in a control unit of the front end circuit of the light source power supply circuit according to the invention. In such alternative arrangement, the fault detection circuit may be configured, as described above, to assess, based on the signals received, the occurrence of a fault in the voltage conversion circuit.
In the embodiment as shown, the voltage conversion circuit further comprises a resistor 360 arranged in series with the load 350. A signal 340.4 representative of the voltage over the resistor 360 is provided to the controller or control unit 340, the signal being representative of the current I through the load 350.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

The term coupled, as used herein, is defined as connected, although not necessarily directly, and not necessarily mechanically.

A single processor or other unit may fulfil the functions of several items recited in the claims.

The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

A computer program may be stored and/or distributed on a suitable medium, such as an optical storage medium or a solid-state medium supplied together with or as part of other hardware, but also be distributed in other forms, such as via the Internet or other wired or wireless telecommunication systems.

1. A light source power supply circuit having multiple output channels, comprising:
a front end circuit comprising a switched mode power converter configured to receive an input voltage and provide a regulated front end DC-voltage;
a plurality of power converter circuits, each of the power converter circuits of the plurality of power converter circuits being configured to receive the regulated front end DC voltage and provide a separate associated DC output for an associated one of the multiple output channels;
a fault detection circuit configured to detect the occurrence of a fault in one or more of the power converter circuits and output, in response, a fault signal;
wherein the front end circuit is provided with an input terminal for receiving the fault signal, and wherein the front end circuit is configured to adjust an output characteristic of the front end circuit based on the received fault signal.

2. The light source power supply according to claim 1, wherein as a result of the adjustment of the output characteristic the power consumed by the front end circuit is limited.

3. The light source according to claim 2, wherein the plurality of power converter circuits are configured to keep providing the separate associated DC output for the associated one of the multiple output channels after the adjustment of the output characteristic of the front end circuit.

4. The light source power supply according to claim 1, wherein the front end circuit is configured to adjust an overload protection limit of the front end circuit based on the received fault signal.

5. The light source power supply according to claim 4, wherein the overload protection limit is adjusted to 100 W.

6. The light source power supply according to claim 1, wherein the front end circuit comprises a switched mode power converter and a control unit for controlling a switching frequency of the switched mode power converter, the control unit comprising an input terminal configured to receive the fault signal and an output terminal configured to output a control signal for controlling the switching frequency, and wherein the control unit is configured to determine the control signal based on the fault signal.

7. The light source power supply according to claim 6, wherein the control unit is configured to reduce a maximum switching frequency of the switched mode power converter based on the fault signal.

8. The light source power supply according to claim 1, wherein the fault detection circuit comprises a voltage sensing circuit configured to sense the regulated front end DC-voltage.

9. The light source power supply according to claim 8, wherein the voltage sensor is configured to output a voltage ripple signal representative of a voltage ripple of the regulated front end DC-voltage.

10. The light source power supply according to claim 9, wherein the fault detection circuit further comprises a control unit configured to receive the voltage ripple signal, to determine, based on the voltage ripple signal, whether or not a fault condition occurs, and to output the fault signal.

11. The light source power supply according to claim 1, wherein the fault detection circuit comprises a current sensing circuit configured to sense a current of the front end circuit or one of the power converter circuits.

12. The light source power supply according to claim 9, wherein the fault detection circuit is configured to determine the fault signal based on the sensed current.

13. The light source power supply according to claim 1, wherein the fault detection circuit comprises a voltage sensing circuit configured to sense a voltage over a switch of the plurality of power conversion circuits.

14. The light source power supply according to claim 13, wherein the fault detection circuit is configured to determine the fault signal based on the sensed voltage.

15. The light source power supply according to claim 6, wherein the control unit is configured to adjust a set point value for the regulated front end DC-voltage based on the fault signal.

16. The light source power supply according to claim 1, wherein the fault signal is provided to the front end circuit via an opto-coupler.
